(19) United States
(12) Patent Application Publication
(10) Pub. No.: US 2011/0302801 A1
(43) Pub. Date: Dec. 15, 2011

(54) Dryer tennis shoe sticker

(76) Inventor: Marvin Lee Jackson, Los Angeles, CA (US)

(21) Appl. No.: 12/798,826

(22) Filed: Jun. 11, 2010

(51) Int. Cl. F26B 25/00

(52) U.S. Cl. 34/239

(57) ABSTRACT

A magnetic shoe drying apparatus is to improve the drying of shoes in a conventional laundry dryer. Apparatus will consist of rods, which will be placed in mouth of the shoe width wise or a horse shoe opener which is to be placed in upper mouth area length wise, to keep mouth of the shoe open during drying process for best drying results. Magnetic device will be placed in bottom heel area of tennis shoe length wise. Magnetic device will be attached to shoe by a heat resistant elastic band or elastic strap with button fasteners which will go around the mouth of the shoe and the magnetic device which is to be attached to the dryer's drum. When the drying process is completed simply remove by pulling magnetic device in shoe from dryer's drum.

### DISCUSSION OF BACKGROUND

For the better part of the 20^{th} century, athletic shoes have been in use all over the world. Most households have at least one pair. They require little maintenance, and only require washing and drying every so often. Laundering athletic shoes requires nothing special; they can be air-dried or put in the dryer.

However, when using a dryer, shoes tumble and bounce loudly, creating a noisy nuisance and potentially causing damage to the dryer and shoe. For this reason, most people prefer to air-dry their athletic shoes, which can take a long time.

I believe there is a need for a device that allows the drying of athletic shoes in a laundry dryer without creating excess noise or risking damage.

### BRIEF DESCRIPTION OF DRAWINGS

FIG. (1): A view of straight frame.

FIG. (2): A view of straight frame with casing integrated into the frame as one piece.

FIG. (3): A view of slightly bent frame with casings integrated into the frame as one piece.

FIG. (4): A view of frame, slightly bent on each end with circular magnets and casings.

FIG. (5): A view of frame, slightly bent on each end with rectangular magnets and casings on each end.

FIG. (6): A view of rods spiked (14) and non-spiked (15).

FIG. (7): A view of flexible horseshoe opener.

FIG. (8): A view of heat resistant elastic strap with button fasteners. Also, hook (1), clip (2), buckle (3), and string fastener (4).

FIG. (8A): A view of heat resistant elastic band.

FIG. (9): A view of pinch rod shoe opener.

FIG. (10): A view of flexible prop mouth opener.

### DETAILED DESCRIPTION OF INVENTION

Referring to FIG. (1) and FIG. (4), frames will be slightly bent on each end to hug the curvature of the dryer drum. Frames will have at least 1 magnet in casing on each end of the magnetic frame.

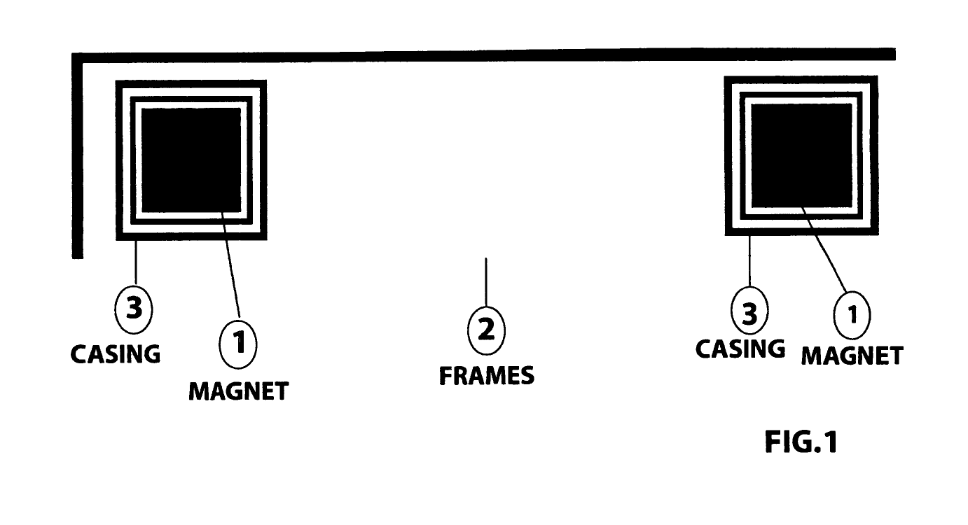

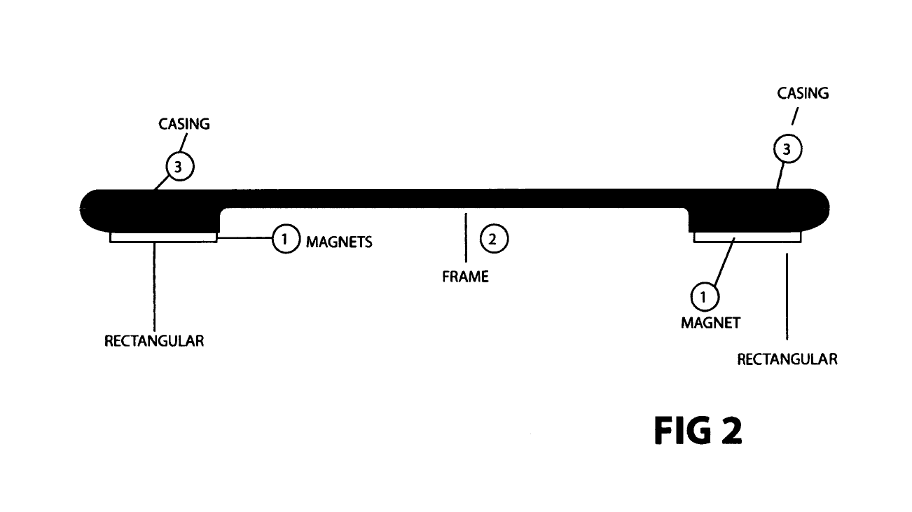

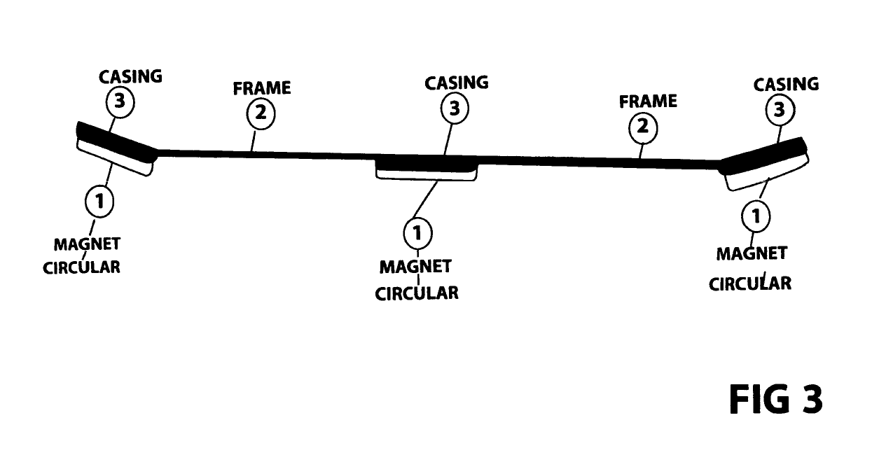

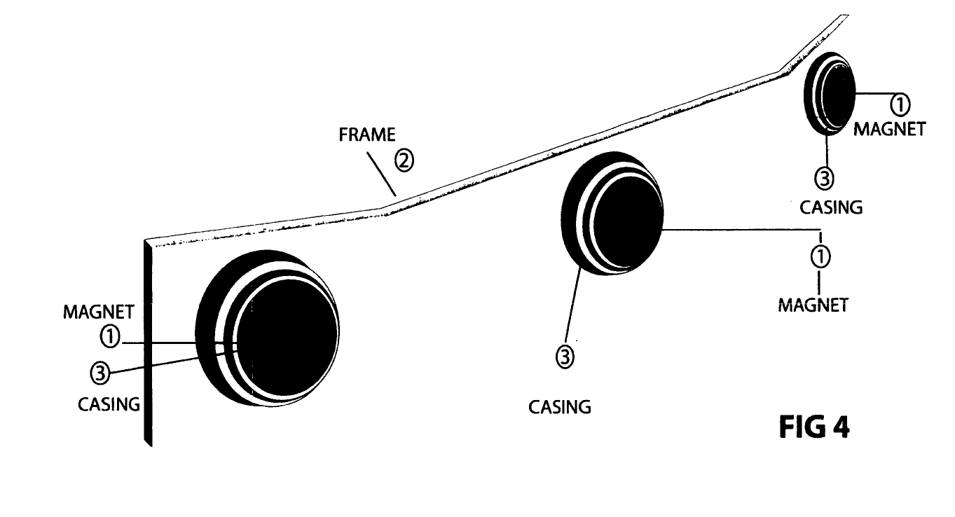

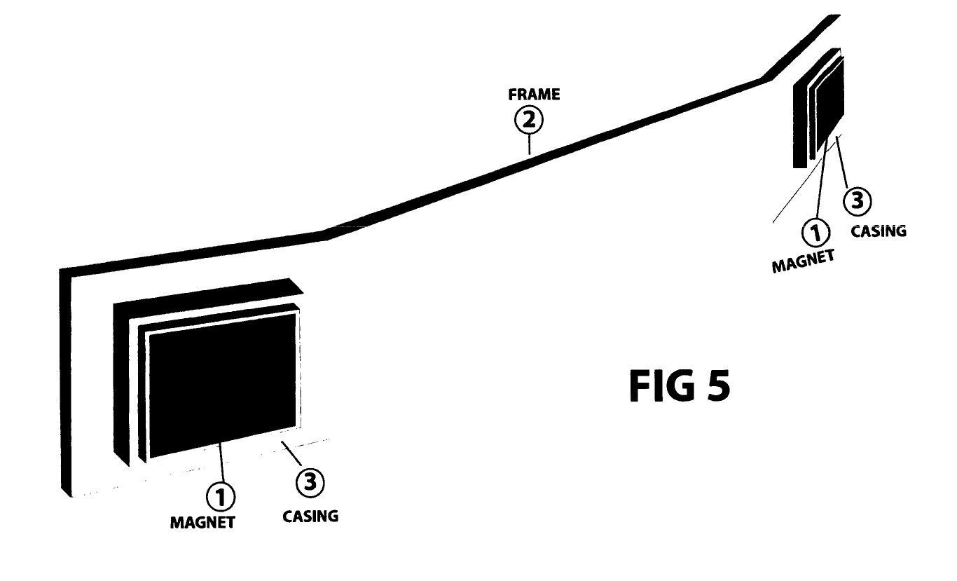

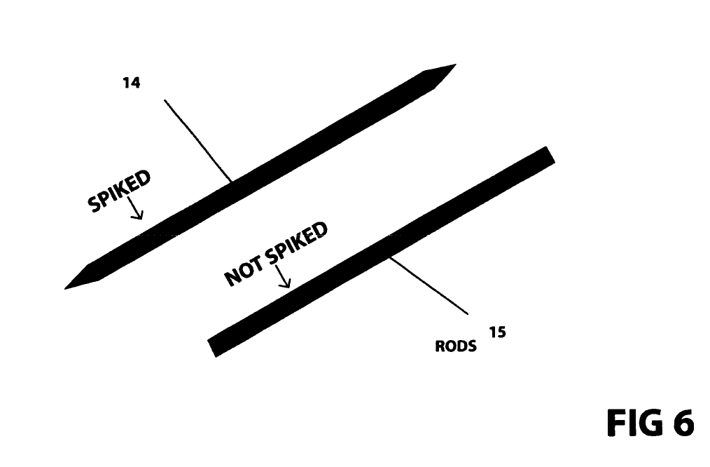

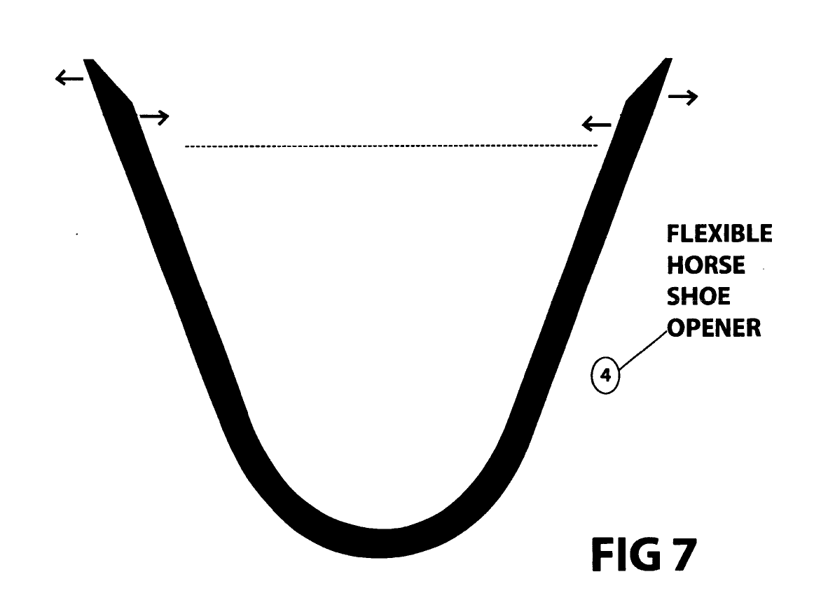

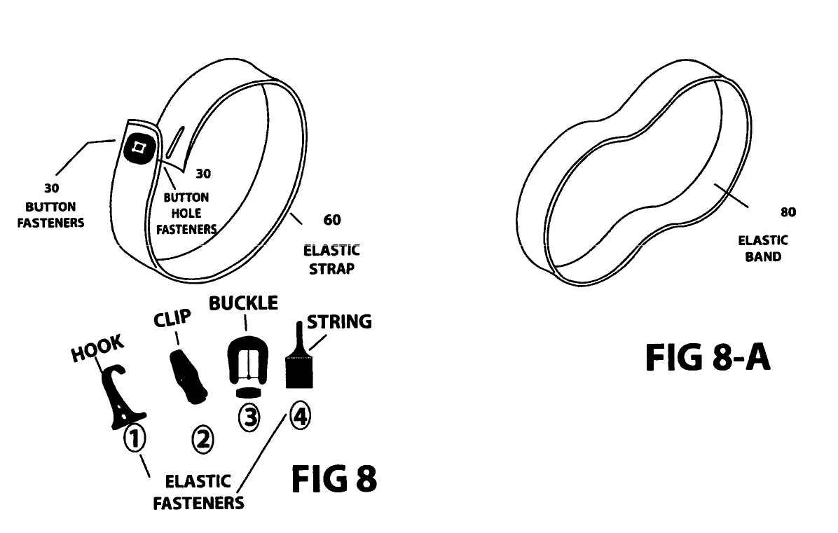

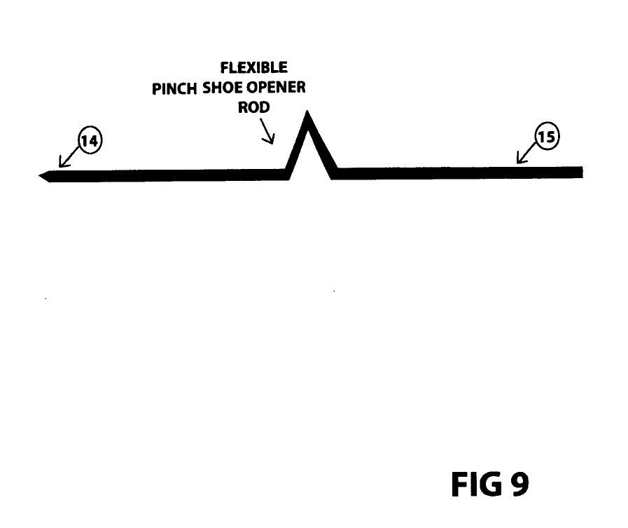

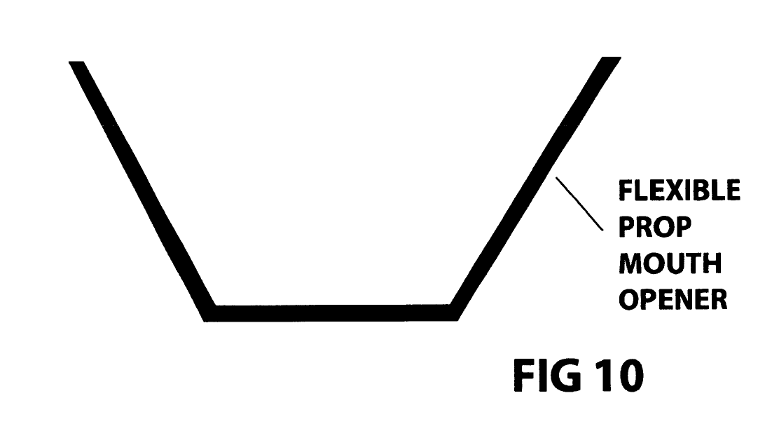

Referring to FIG. 5, frame will be straight to attach to axis of rotation of dryer drum. All magnetic frames will have one casing (3) and one magnet (1) combined on each end of metal frames (2). All casings will be attached to metal frames by rivets or screws. Magnets will be fitted down into casings by powerful heat resistant super glue; magnets and casings can also be rectangular shape, or other shapes. For magnets, refer to (1); for casings, refer to (3); for frames, refer to (2). All frames can have a 3^{rd} magnet and a 3^{rd} casing in center of frame. All frames will have a length of 9 to 14 inches, a width of V2 to 1 inch and a thickness of Y2 to 2 millimeters between magnet and casing areas. Casing and magnet area frames will be ½ to 1 inch thick. Refer to FIGS. (2) and (3); casings can be integrated into the frame as one piece. Frames of fiberglass, wood, plastic and rubber casings will be integrated into the frame as a single piece. Magnets and casings can also be circular, rectangular, or other shapes.

Referring to FIG. (10), flexible prop mouth opener will be placed in shoe width-wise in arch area to keep the front mouth area of the shoe open.

Referring to FIG. (6) consisting of two rods that are spiked on each end or smooth edged on each end (14) (15), which is to keep the mouth of the tennis shoe open during drying process. Rods will be 5 to 6 inches in length and ½ to 1 millimeter in thickness.

Referring to FIG. (7), horseshoe opener will be 5 to 8 inches in length, ½ to 1 inch in width and Y2 to 1 millimeter in thickness, which is to be placed in the open mouth of the tennis shoe. Horseshoe opener is to be placed in upper mouth area of shoe, length-wise.

Referring to FIG. (8-A), heat resistant elastic band will be 4 to 6 inches in length, 3 mm to 1 inch in width and ½ to 1 millimeter in thickness. Band can be replaced with powerful heat resistant rubber band and other fabrics. Referring to FIG. (8), band can be replaced with a powerful heat-resistant elastic strap with button fasteners. Heat resistant elastic strap will be 8 to 12 inches in length, Y2 to 1 inch in width, and ½ millimeter to 1 millimeter in thickness. Fasteners can be hooks (1), clips (2), buckle (3), or string fastener (4).

Referring to FIG. (9) will be pinch rod shoe opener, which is used to keep the mouth of the shoe open, and will be placed width-wise in upper mouth area of shoe. It can either be spiked(14) or non-spiked(15) on each end. Pinch rod will be 5 to 6 inches in length, and ½ to 1 millimeter in thickness.

What is claimed is:

1. The magnetic frame of claim #1 consisting of heat resistant elastic band. Also consisting of rods or horseshoe opener, or pinch rod shoe opener, for keeping the mouth of a tennis shoe open, which attaches a shoe to a magnetic frame. The band is to go around the mouth of the shoe and the magnetic frame, and the magnetic frame is to be attached to dryer drum. Powerful heat resistant elastic strap with button fastener can also go around the mouth of the shoe and the magnetic device.
2) The magnetic frame of claim #1 can be slightly bent on each end to hug curvature of the dryer drum.
3) The magnetic frame of claim #1 can be straight and attached to axis of the curvature of the drum.
4) The magnetic frame of claim #1 wherein the frame of wood, fiberglass, plastic or rubber; the casings will be integrated into all frames as a single piece.
5) The magnetic frame of claim #1 wherein the frame magnets and casing combined can either be circular magnets in casings.
6) The magnetic frame of claim #1 wherein magnets and casing can also be rectangular or other shapes on all frames. Magnets can be ceramic or metallic, or other magnet materials manufactured and sold in the USA.
7) The magnetic frame of claim #1 wherein the magnetic frame will have at least one magnet and combined casing on each end of the frame may be one in the center. Casings can be attached to metal frame by rivets or screws.
8) All magnetic frames of Claim #1 will have a length anywhere from 9 to 14 inches. The space between magnet and casings will be ½ to 2 millimeters thick. Magnet in casing areas will be ½ to 1 inch thick. All frames will be ½ to 1 inch in width.

2.
1) An elastic band of claim #2: An elastic band would have a length between 4 to 6 inches in length can also be made of powerful heat resistant rubber band or nylon band or other flexible materials or not. Band can be replaced by a powerful heat resistant elastic strap with button fastener. Heat resistant elastic strap will be 8 to 12 inches in length, ½ to 1 inch in width, and ½ to 1 millimeter in thickness. Button fastener can be replaced by hook, clip, buckle, or string fasteners; permanently attached to elastic strap.
2) An elastic band of claim #2: Elastic band would have a width of approximately 3 mm to 1 inch in width.
3) An elastic band of claim #2: Elastic band would have a thickness of ½ mm to 1 mm thickness.
4) An elastic band of claim #2 can be made of other stretchable materials or not.

3.
(1) A horseshow opener of claim #3: Horseshoe can be flexible and have a length within the range of 5 to 8 inches.
(2) A horseshoe opener of claim #3: Horseshoe opener would have a thickness from ½ mm to 1 mm and a width of ½ to 1 inch.
(3) A horseshoe opener of claim #3: Horseshoe opener can be made of such material as wood, fiberglass, metal, plastic, and rubber. Heat resistant or not, very flexible or not.
(4) A horseshoe opener of claim #3: can be replaced by flexible prop mouth opener which will be 1 to 4 inches in width or non-flexible horseshoe opener will be fitted into upper mouth area of shoe.

4.
(1) Rods of claim #4: Rod will have a length within the range of 5 to 6 inches. In length, rods will be placed width wide in upper mouth area by lacing area.
(2) Rods of claim #4; Rods can be replaced by pinch rod shoe opener which will have a length of 5 to 6 inches. They can either be spiked or smooth edged and will have a thickness of ½ mm to 1 mm thick.
(3) Rods of claim #4: will be made of such materials as metal, fiberglass, wood, plastic, rubber, and other materials heat resistant or not and non-flexible or flexible. All shoe openers can be made of the same materials.
